(19) United States
(12) Patent Application Publication
(10) Pub. No.: US 2018/0113950 A1
(43) Pub. Date: Apr. 26, 2018

(54) QUERYNG GRAPH TOPOLOGIES

(71) Applicant: Hewlett Packard Enterprise Development LP, Houston, TX (US)

(72) Inventor: Sean Blanchflower, Cambridge (GB)

(21) Appl. No.: 15/332,448

(22) Filed: Oct. 24, 2016

(51) Int. Cl. G06F 17/30; G06N 99/00; G06N 5/04

(52) U.S. Cl. CPC G06F 17/30958; G06N 5/04; G06N 99/005; G06F 17/30979

(57) ABSTRACT

In some examples, a query answering (QA) system to query a graph topology may include a physical processor that executes machine readable instructions that cause the processor to obtain a query provided by a user to query the graph topology. An actual answer to the query is unknown from the graph topology. Furthermore, the machine readable instructions cause the processor to query a set of nodes and a set of edges in the graph topology associated with the obtained query. Querying the set of nodes and edges comprises applying neighboring graph structure statistics to the set of nodes and edges to obtain a set of node grouping patterns and each of the node grouping patterns comprises an associated score within the graph topology. Furthermore, the machine readable instructions cause the processor to identify a set of unconnected nodes within the obtained set of patterns based on the associated score, infer one or more edges to link the set of unconnected nodes based on machine learning and feedback techniques and provide a most-likely answer to the query based on the linking of the set of unconnected nodes.

### BACKGROUND

An extended graph topology comprising explicit graph edges can be processed by systems comprising tools, libraries and frameworks. These systems processing the graph topology may rely on the explicit graph edges to obtain answers to queries.

### BRIEF DESCRIPTION OF THE DRAWINGS

FIG. 1 is a block diagram of an example query answering system for querying a graph topology.

FIG. 2 is a block diagram of another example query answering system for querying a graph topology.

FIG. 3 is a flowchart of an example process for querying a graph topology.

FIG. 4 is a block diagram of an example machine-readable storage medium including instructions to query a graph topology.

### DETAILED DESCRIPTION

The desire for computers to give direct answers to human questions has proven a popular field of research for many years. Techniques can be used to create query answering (QA) systems to give direct answers to human questions or queries. In this particular field, the use of graphs has also proven popular. Existing systems may rely either on graph databases with complete knowledge, or on unstructured systems that require specialized technology for analysis. A QA system is any system or method that produces answers to queries and may associate those answers with confidences indicating the likelihood the answers can be correct, and that may associate answers with a passage-based justification that are intended to explain to humans why the answer is likely correct. A system that gives direct answers to human questions using graph topologies by interrogating the graph may rely on explicit elements of the graph topology, such as explicit graph edges to provide an answer to a query. In these cases, if an element of the graph is missed, a (human) question queried to the system may not be answered as the query of the graph topology may be incomplete due to missed parts of the graph topology (e.g., where explicit graph edges do not link to the missed parts).

A query may be defined as a single sentence or phrase in natural language (e.g., English) or a formal language (e.g., First order logic) that may intend to ask for the end point(s) of a relation or to ask whether or not a relation between two concepts can be true. A relation may be a named association between two concepts. General examples of relations include: A “indicates” B, A “causes” B, A “treats” B, A “activates” B, and A “discovered” B. The concepts can be considered the “arguments” or “end points” of the relation. An answer or solution can be an element of text: a word, number, phrase, sentence, passage or document. An actual answer is thought to be correct or partially correct with respect to a query if a human considers it useful response to the query. Thus, an actual answer may be provided by a user or otherwise determined by a QA system. In the case of a simple query or relation, the answer is typically the sought-after end-point of the relation.

The present disclosure proposes a solution applied for a QA system which may provide strong guessing capabilities responsive to querying a graph topology as a knowledge base. The QA system can provide a most-likely answer (e.g., with a highest likelihood score) to a query related to an actual answer, and node grouping patterns can be used to perform edge inference among unconnected nodes within the patterns in the graph topology. As an illustrative example, the QA system proposed in the present disclosure may imitate human thinking to find a most likely answer to a question such as a question asking: “How many legs does a Pomeranian have?”. If the human is unaware that a Pomeranian is a dog, then he could resort to other information to arrive at the most likely answer. Perhaps the human could see an advertisement at a pet store offering “White Pomeranians for sale”, or he may know that a friend had bought one for her elderly mother. He could thus make a strong guess that the Pomeranians have four legs as the most likely answer, even if he can't be 100% certain.

The QA system proposed in the present disclosure can implement natural language processing (NLP) through machine learning techniques, for example, in order to answer questions posed by humans in a natural language. Some major tasks in NLP that can be implemented by the proposed QA system can include, e.g., morphological segmentation, named entity recognition (NER), natural language generation and understanding, optical character recognition, relationship extraction, sentence breaking, speech recognition and processing, word segmentation, information retrieval IR, etc.

The structured database of knowledge of information, e.g. the knowledge base described herein, can be a graph topology. A graph topology or inference graph can be any graph represented by a set of nodes connected by edges, where the nodes can represent statements and the edges or arcs can represent relations between statements. Each relation may be associated with a confidence, and each concept in a relation may be associated with a confidence. Each edge can be associated with a set of passages providing a justification for why that relation may be true. Each passage justifying an edge may be associated with a confidence indicating how likely the passage justifies the relation. An inference graph can be used to represent relation paths between factors in an inquiry and possible answer to that inquiry. An inference graph is multi-step if it contains more than one edge in a path from a set of factors to an answer.

In an example according to the present disclosure, a query answering system to query a graph topology includes a physical processor and a non-transitory memory storing machine-readable instructions. The machine-readable instructions, when executed, can cause the processor to obtain a query provided by a user to query the graph topology, where an actual answer to the query may be unknown from the graph topology and to query a set of nodes and a set of edges in the graph topology associated with the obtained query. In this respect, querying the set of nodes and edges can comprise applying neighboring graph structure statistics to the set of nodes and edges to obtain a set of node grouping patterns and where each of the node grouping patterns can comprise an associated score within the graph topology. Furthermore, the machine-readable instructions, when executed, can cause the processor to identify a set of unconnected nodes within the obtained set of patterns based on the associated score, infer one or more edges to link the set of unconnected nodes based on machine learning and feedback techniques and provide a most-likely answer to the query based on the linking of the set of unconnected nodes.

In another example according to the present disclosure, a method can be implemented or performed by a query answering system including a physical processor executing machine readable instructions. The method may include obtaining a query provided by a user to query the graph topology. An actual answer to the query is unknown from the graph topology. The method may further comprise querying a set of nodes and a set of edges in the graph topology associated with the obtained query, where querying the set of nodes and edges comprises applying neighboring graph structure statistics to the set of nodes and edges to obtain a set of node grouping patterns and where each of the node grouping patterns comprises an associated score within the graph topology. The method may comprise identifying a set of unconnected nodes within the obtained set of patterns based on the associated score, inferring one or more edges to link the set of unconnected nodes based on machine learning and feedback techniques, obtaining a set of likely answers to the query ranked by likelihood based on the linking of the set of unconnected nodes and providing a likely answer from the set based on a highest likelihood score.

In another example according to the present disclosure, a non-transitory machine-readable storage medium may be encoded with instructions to query a graph topology. The non-transitory machine-readable storage medium may comprise instructions to obtain a query provided by a user to query the graph topology. An actual answer to the query is unknown from the graph topology. The non-transitory machine-readable storage medium may comprise instructions to query a set of nodes and a set of edges in the graph topology associated with the obtained query, where querying the set of nodes and edges comprises applying neighboring graph structure statistics to the set of nodes and edges to obtain a set of node grouping patterns and where each of the node grouping patterns comprises an associated score within the graph topology. The non-transitory machine-readable storage medium may comprise instructions to identify a set of unconnected nodes within the obtained set of patterns based on the associated score, infer one or more edges to link the set of unconnected nodes based on neural networks, obtain a set of likely answers to the query ranked by likelihood based on the linking of the set of unconnected nodes and provide a likely answer from the set based on a highest likelihood score.

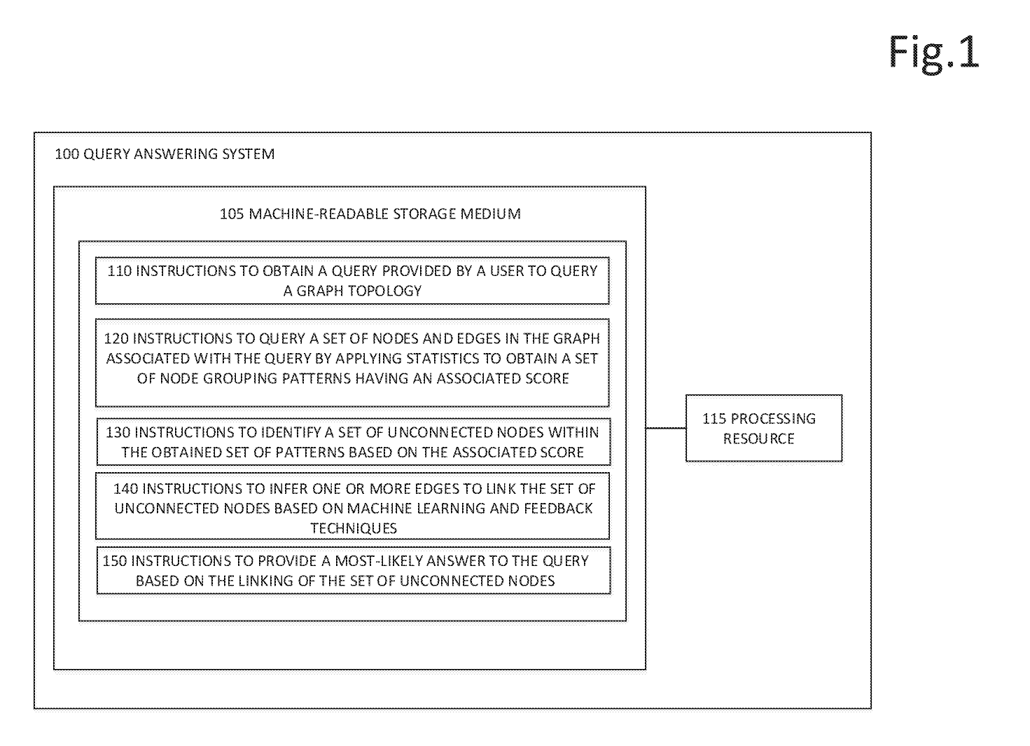

Referring now to the drawings, FIG. 1 shows an example of a query answering system 100 to query a graph topology. The query answering system 100 may be, for example, a cloud server, a local area network server, a web server, a mainframe, a mobile query answering system, a notebook or desktop computer, a smart TV, a point-of-sale device, a wearable device, any other suitable electronic device, or a combination of devices, such as ones connected by a cloud or internet network, that perform the functions described herein. In the example shown in FIG. 1, the query answering system 100 includes a processing resource 115 and a non-transitory machine-readable storage medium 105 encoded with instructions to query a graph topology.

The processing resource 115 may be one or more central processing units (CPUs), semiconductor-based microprocessors, and/or other hardware devices suitable for retrieval and execution of instructions stored in a machine-readable storage medium 105. The processing resource 115 may fetch, decode, and execute instructions 110, 120, 130, 140 and 150 and/or other instructions to implement the procedures described herein. As an alternative or in addition to retrieving and executing instructions, the processing resource 115 may include one or more electronic circuits that include electronic components for performing the functionality of one or more of instructions 110, 120, 130, 140 and 150.

In an example, the program instructions 110, 120, 130, 140 and 150, and/or other instructions can be part of an installation package that can be executed by the processing resource 115 to implement the functionality described herein. In such a case, the machine-readable storage medium 105 may be a portable medium such as a CD, DVD, or flash drive or a memory maintained by a query answering system from which the installation package can be downloaded and installed. In another example, the program instructions may be part of an application or applications already installed on the query answering system 100.

The machine-readable storage medium 105 may be any electronic, magnetic, optical, or other physical storage device that contains or stores executable data accessible to the query answering system 100. Thus, the machine-readable storage medium 105 may be, for example, a Random Access Memory (RAM), an Electrically Erasable Programmable Read-Only Memory (EEPROM), a storage device, an optical disc, and the like. The machine-readable storage medium 105 may be a non-transitory storage medium, where the term “non-transitory” does not encompass transitory propagating signals. The machine-readable storage medium 105 may be located in the query answering system 100 and/or in another device in communication with the query answering system 100.

As described in detail below, the machine-readable storage medium 105 may be encoded with instructions 110 to obtain a query provided by a user to query the graph topology. An actual answer to the query may be unknown from the graph topology but known by the user providing the query. Instructions 120 can query a set of nodes and a set of edges in the graph topology associated with the obtained query. Querying the set of nodes and the set of edges may comprise applying neighboring graph structure statistics to the set of nodes and edges to obtain a set of node grouping patterns upon execution of instructions 120. In this respect, each of the node grouping patterns can comprise an associated score within the graph topology. Instructions 130 can identify a set of unconnected nodes within the obtained set of patterns based on the associated score of the node grouping patterns. Furthermore, instructions 140 can infer one or more edges to link the set of unconnected nodes based on machine learning and feedback techniques and instructions 150 can provide a most-likely answer to the query based on the linking of the set of unconnected nodes.

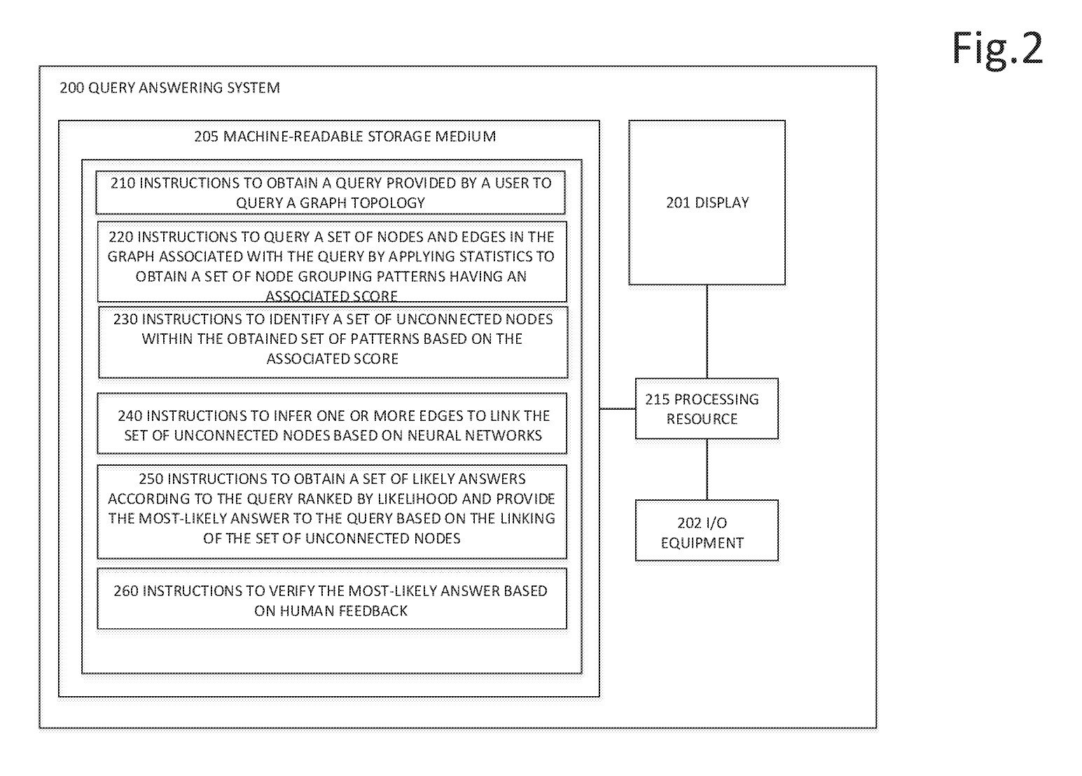

FIG. 2 shows a query answering (QA) system 200 to query a graph topology according to another example of the present disclosure. The QA system 200 may comprise a processing resource 215 and a machine-readable storage medium 205 comprising (e.g., storing) instructions to query a graph topology. Furthermore, the QA system 200 comprises a display 201 and input-output equipment 202. Examples of input-output equipment 202 can comprise a keyboard, microphone, webcam, connectors, etc.

The machine-readable storage medium 205 can comprise instructions 210 to obtain a query provided by a user to query the graph topology. Instructions 210 may cause the QA system 200 to identify a set of nodes and a set of edges within the graph topology associated with the query by parsing the query. In an example, instructions 210 may perform NLP as e.g. information retrieval IR and text recognition in order to parse the query and identify a set of nodes and edges associated with the query. In an example according to the present disclosure the query may be e.g., ASCII characters, files as text documents, images, audio, mind maps, videos, etc.

In an example, the instructions 210 to obtain a query provided by a user to query the graph topology can comprise instructions to present a blank record in the display 201 that may permit the user to specify the query by means of a keyboard comprised within the I/O equipment 202. In another example, instructions 210 to obtain a query provided by a user to query the graph topology can comprise instructions to obtain the query according to voice recognition via a voice sensor as e.g. a microphone comprised in the I/O equipment 202.

The machine-readable storage medium 205 can comprise instructions 220 to query a set of nodes and a set of edges in the graph topology associated with the obtained query, which may cause the QA system 200 to query the set of nodes and edges by applying neighboring graph structure statistics to the set of nodes and edges to obtain a set of node grouping patterns. In this respect, the present solution can take use of the obtained set of node grouping patterns within the graph topology itself to infer related edges within the graph topology in order to obtain a most-likely answer to the query.

In an example, the neighboring graph structure statistics use a nearest neighbor search (NNS) for finding the most likely nodes based on the query and data mining processing for graph databases as, e.g., sequential pattern mining in order to discover patterns in the graph topology from a macroscopic graph analysis. The NNS applied in the present disclosure can be defined as an optimization problem for finding the most similar nodes in the graph topology having as starting points the nodes and edges extracted from the query. In an example, the associated score can be a likelihood score based on the actual answer. The likelihood score can be, e.g., a percentage value or an integer or it can be a number of edge hops between nodes associated with the query and the actual answer.

In another example, statistical measures as, e.g., the covariance or the mean of node properties can be obtained in order to find related likely nodes within the graph topology to the nodes from the set of nodes associated with the query based on the aforementioned statistical measures and include the found nodes into one or more node grouping patterns. Node grouping patterns may be redefined based on statistics results and likelihood optimization.

In another example, responsive to having a graph topology having one edge with no attributes linking two nodes, the statistics used may comprise deciding whether there's a link or not, if there is a link from where it may come from and counting of other links. As an analogy of this type of graph to the human brain, the statistics can work by deciding whether there are links between neurons or not. Hence, this measure can become hugely powerful when the large number of links work all together from a macrocospic perspective of the brain. This analogy can apply to graph topologies that can be used by the QA system 100, the QA system 200, or any other system implementing the features disclosed herein.

The machine-readable storage medium 205 can comprise instructions 230 to identify a set of unconnected nodes within the obtained set of node grouping patterns. Instructions 230 may take use of the associated likelihood scores in the node grouping patterns. Hence, the most likely unconnected nodes in a node grouping pattern may identified based on statistics for performing edge inference.

The machine-readable storage medium 205 can comprise instructions 240 to infer one or more edges to link the set of identified unconnected nodes from the set of node grouping patterns based on machine learning and feedback techniques. An example of machine learning techniques can be, e.g., neural networks applied for edge inference. The inference of one or more edges may provide one or more new paths, e.g, the one or more new paths in the graph topology may comprise previously-unconnected nodes from the set of node grouping patterns now linked based on edge inference. Hence, instructions 240 may permit the graph to connect or link the set of nodes associated with the obtained query in order to arrive at a most-likely answer representing the actual answer over one or more paths having one or more edges representing relations between the query and the actual answer. These one or more paths may represent one or more solutions in the graph to the actual answer and these one or more paths may have an associated likelihood score.

The machine-readable storage medium 205 can comprise instructions 250 to provide a set of likely answers according to the query, and this set of likely answers may be ranked by likelihood. Instructions 250 may select a most-likely answer to the query based on the linking of the set of unconnected nodes. The one or more paths may represent one or more solutions in the graph to the actual answer and they may be classified based on an associated likelihood score. Hence, instructions 250 my select the most-likely answer associated with a path with a highest likelihood score obtained by executing instructions 240. In an example according to the present disclosure, the most-likely answer may be equal to the actual answer that can be known by the user. Hence, the likelihood score of the most-likely answer can be, e.g., 100%.

The machine-readable storage medium 205 can comprise instructions 260 to verify the most-likely answer based on human feedback. Human feedback may be obtained by means of the I/O equipment 202. The human feedback representing the actual answer once processed by the QA system 200 may be analyzed and compared against the most-likely answer obtained by the QA system 200.

In an example, the machine-readable storage medium 205 may be encoded with instructions to provide a likelihood score associated with the most-likely answer. This provided likelihood score may be the highest likelihood score obtained by the QA system 200. The likelihood score associated with the most-likely answer may be displayed in the display 201.

In an example, the machine-readable storage medium 205 may be encoded with instructions to query the graph topology and obtain a set of node grouping patterns that comprise instructions to apply community detection algorithms to node properties of the graph topology associated with the obtained query and wherein these nodes may contain information about people. Different communities can be represented as different nodes in the graph. This algorithm may apply a filter that may be useful in the cases when a different mapping of information is needed. Some examples of community filtering may be to access the information filtered per period, location or gender.

In another example, the machine-readable storage medium 205 may be encoded with instructions to query the graph topology and obtain a set of node grouping patterns that comprise instructions to apply a decay function on timestamped data associated with the graph, e.g. some existing timestamp relationships in the graph could be ignored in the graph if they happen to be very old. This function may apply a filter that may be useful in the cases where the old data may not be relevant anymore.

In another example, the machine-readable storage medium 205 may be encoded with instructions to query the graph topology and obtain a set of node grouping patterns that comprise instructions to apply a triadric closure (e.g. transitivity) to measure the strength of the connection of data among nodes. Triadic closure is the property among three nodes A, B, and C, such that if a strong tie exists between A-B and A-C, there is a weak or strong tie between B-C. It can be a method commonly used in social networks to identify further connections between its users.

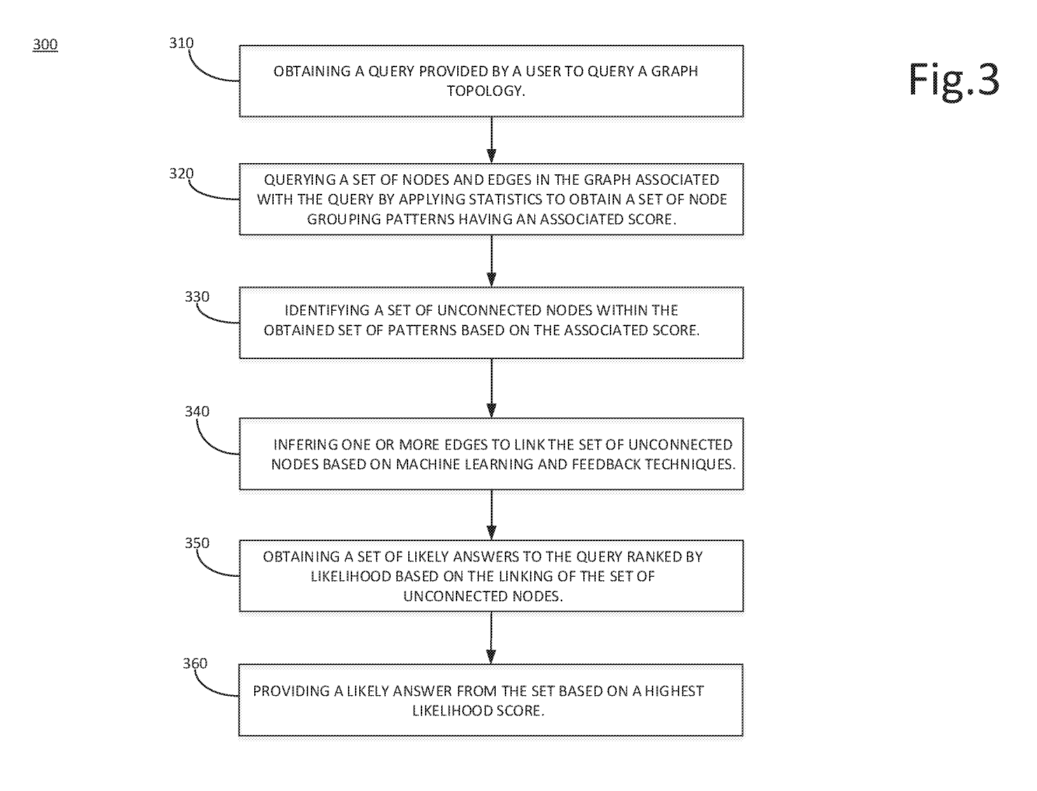

Turning now to FIG. 3, this figure shows a flowchart of an example process implemented by a query answering QA system for querying a graph topology. The process 300 comprises block 310 for obtaining a query provided by a user to query a graph topology upon executing instructions 110 or 210. In block 310 a set of nodes and a set of edges within the graph topology associated with the query may be identified by parsing the query. In an example, in block 310 NLP as, e.g., information retrieval IR and text recognition may be performed in order to parse the query and identify a set of nodes and edges associated with the query. In an example according to the present disclosure, the query may be e.g., ASCII characters, files as text documents, images, audio, mind maps, videos, etc.

The process 300 further comprises block 320 for querying a set of nodes and edges in the graph associated with the query upon executing instructions 120 or 220. Neighboring graph structure statistics may be applied in block 320 in order to obtain a set of node grouping patterns where each of the node grouping patterns can comprise an associated score within the graph topology. In one example, neighboring graph structure statistics can take use of nearest neighbor search NNS for finding the most likely nodes based on the query and data mining processing for graph databases as e.g. sequential pattern mining in order to discover patterns in the graph topology from a macroscopic graph analysis. In another example, statistical measures as, e.g., the covariance or the mean of node properties can be obtained in order to find related likely nodes within the graph topology to the nodes associated with the query based on the aforementioned statistical measures and identify the found nodes into one or more node grouping patterns. Node grouping patterns may be redefined based on statistics results and likelihood optimization. In another example, responsive to having a graph topology having one edge with no attributes linking two nodes, the statics used may comprise deciding whether there's a link or not, who may be from and counting of other links.

The process 300 further comprises block 330 for identifying a set of unconnected nodes within the obtained set of node grouping patterns based on the associated score upon executing instructions 130 or 230. The most likely unconnected nodes in a node grouping pattern may identified based on statistics for performing edge inference. In another example, one or more unconnected nodes having a similar associated likelihood score may be identified. Block 330 may take use of the associated likelihood scores in the node grouping patterns. The likelihood score can be e.g. a percentage value or an integer or it can be a number of edge hops between nodes associated with the query and the actual answer.

The process 300 further comprises block 340 for inferring one or more edges to link the set of unconnected nodes based on machine learning and feedback techniques upon executing instructions 140 or 240. An example of machine learning techniques can be, e.g., neural networks applied for edge inference. The inference of one or more edges may provide one or more new paths based on the graph topology, e.g. the one or more new paths in the graph topology may comprise previously-unconnected nodes from the set of node grouping patterns now linked based on edge inference. Hence, block 340 upon executing instructions 140 or 240 may permit the graph to connect or link the set of nodes associated with the obtained query in order to obtain a most-likely answer representing the actual answer that may be known by the user over one or more paths having one or more edges representing relations between the query and the actual answer. These one or more paths may represent one or more solutions in the graph to the actual answer and these one or more paths may have an associated likelihood score.

The process 300 further comprises block 350 for obtaining a set of likely answers to the query ranked by likelihood based on the linking of the set of unconnected nodes upon executing instructions 250. Block 350 may select a most-likely answer to the query based on the linking of the set of unconnected nodes previously performed in block 340. The one or more paths obtained in block 340 may represent one or more solutions in the graph to the actual answer and they may be classified based on an associated likelihood score. Hence, block 350 may select the most-likely answer associated with a path with a highest likelihood score. In an example according to the present disclosure, the most-likely answer may be equal to the actual answer that can be known by the user. Hence, the likelihood score of the most-likely answer can be e.g. 100%.

The process 300 further comprises block 360 for providing a likely answer from the set based on a highest likelihood score upon executing instructions 250. One of the likely answers may be identified as the most-likely answer responsive to having the highest likelihood score. In an example, the likelihood score of the most-likely answer, i.e. the most-likely answer can be provided to the user.

In another example, the process 300 may comprise a block for presenting a blank record on a display that may permit the user to specify the query by means of a keyboard. In another example, the process 300 may comprise a block to obtain the query according to voice recognition via a voice sensor as e.g, a microphone.

In another example, the process 300 may comprise a block for verifying whether the most-likely answer is the actual answer based on human feedback. Human feedback representing the actual answer once processed by the QA system performing the process 300 may be analyzed and compared against the most-likely answer obtained under block 360.

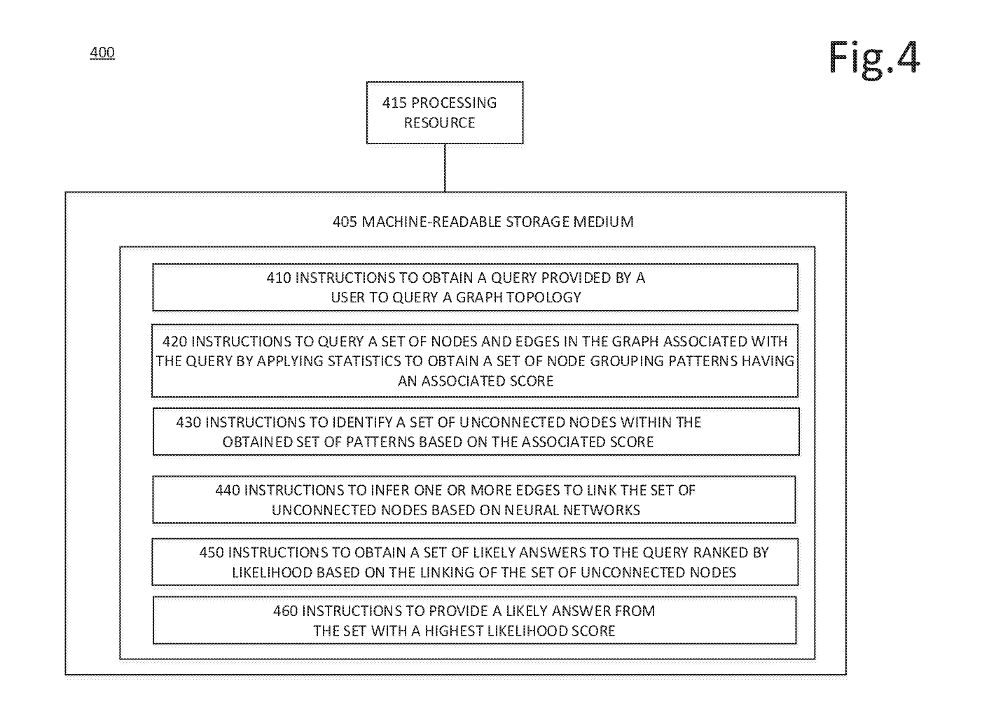

Turning now to FIG. 4. FIG. 4 shows a block diagram 400 of an example non-transitory machine-readable storage medium 405. The non-transitory machine-readable medium 405 may include instructions executed in a query answering QA system as the examples shown in FIG. 1 and FIG. 2. The non-transitory machine-readable medium 405 can store machine-readable instructions executable by a processing resource 415. The non-transitory machine-readable medium 405 can comprise instructions 410 to obtain a query provided by a user to query the graph topology. The actual answer to the query can be unknown from the graph topology.

The non-transitory machine-readable medium 405 can comprise instructions 420 to query a set of nodes and a set of edges in the graph topology associated with the obtained query. Querying the set of nodes and edges can comprise applying neighboring graph structure statistics to the set of nodes and edges to obtain a set of node grouping patterns. Furthermore each of the node grouping patterns can comprise an associated score within the graph topology. Neighboring graph structure statistics may be applied by executing instructions 420 in order to obtain a set of node grouping patterns where each of the node grouping patterns can comprise an associated score within the graph topology.

In one example, neighboring graph structure statistics can take use of nearest neighbor search NNS for finding the most likely nodes based on the query and data mining processing for graph databases as e.g. sequential pattern mining. In another example, statistical measures as e.g. the covariance or the mean of node properties can be obtained. Hence, node grouping patterns may be redefined based on statistics results and likelihood optimization. In another example, responsive to having a graph topology having one edge with no attributes linking two nodes, the statics used may comprise deciding whether there's a link or not, who may be from and counting of other links.

The non-transitory machine-readable medium 405 can comprise instructions 430 to identify a set of unconnected nodes within the obtained set of patterns based on the associated score. In one example, instructions 430 can comprise instructions to identify a set of unconnected nodes having a similar associated score. The most likely unconnected nodes in a node grouping pattern may identified based on statistics for performing edge inference. In another example, one or more unconnected nodes having a similar associated likelihood score may be identified. The instructions 430 may take use of the associated likelihood scores in the node grouping patterns.

The non-transitory machine-readable medium 405 can comprise instructions 440 to infer one or more edges to link the set of unconnected nodes based on neural networks. The inference of one or more edges may provide one or more new paths based on the graph topology, e.g. the one or more new paths in the graph topology may comprise previously-unconnected nodes from the set of node grouping patterns now linked based on edge inference. Instructions 440 may permit to link unconnected nodes associated with the obtained query in order to obtain a most-likely answer representing the actual answer over one or more paths having one or more edges representing relations between the query and the actual answer. These one or more paths may represent one or more solutions in the graph to the actual answer and these one or more paths may have an associated likelihood score.

The non-transitory machine-readable medium 405 can comprise instructions 450 to obtain a set of likely answers to the query ranked by likelihood based on the linking of the set of unconnected nodes. Instructions 450 may select a most-likely answer to the query based on the linking of the set of unconnected nodes previously performed by instructions 440. The one or more paths obtained by instructions 440 may represent one or more solutions in the graph to the actual answer and they may be classified based an associated likelihood score. The likelihood score can be e.g. a percentage value or an integer or it can be a number of edge hops between nodes associated with the query and the actual answer.

The non-transitory machine-readable medium 405 can comprise instructions 460 to provide a likely answer from the set based on a highest likelihood score. Hence, instructions 460 may select the most-likely answer associated with a path with a highest likelihood score. In an example according to the present disclosure, the most-likely answer may be equal to the actual answer that can be known by the user. Hence, the likelihood score of the most-likely answer can be e.g. 100%.

The non-transitory machine-readable medium 405 can further comprise machine-readable instructions to verify whether the most-likely answer is the actual answer based on human feedback. The human feedback representing the actual answer can be processed and compared against the most-likely answer obtained by the QA system comprising the machine-readable medium 405.

The non-transitory machine-readable medium 405 can further comprise machine-readable instructions to provide the highest likelihood score of the most-likely answer. One of the likely answers may be identified as the most-likely answer responsive to having the highest likelihood score. The likelihood score of the most-likely answer, i.e. the most-likely answer can be provided to the user, as e.g. displaying the most-likely answer in a display.

The sequence of operations described in connection with FIGS. 1 to 4 are examples and are not intended to be limiting. Additional or fewer operations or combinations of operations may be used or may vary without departing from the scope of the disclosed examples. Furthermore, implementations consistent with the disclosed examples may not perform the sequence of operations or instructions in any particular order. Thus, the present disclosure merely sets forth possible examples of implementations, and many variations and modifications may be made to the described examples. All such modifications and variations are intended to be included within the scope of this disclosure and protected by the following claims.

What is claimed is:

1. A query answering (QA) system to query a graph topology, the system comprising:
a physical processor; and
a non-transitory memory storing machine-readable instructions to cause the processor to:
obtain a query provided by a user to query the graph topology,
wherein an actual answer to the query is unknown from the graph topology;
query a set of nodes and a set of edges in the graph topology associated with the obtained query,
wherein querying the set of nodes and edges comprises applying neighboring graph structure statistics to the set of nodes and edges to obtain a set of node grouping patterns; and
wherein each of the node grouping patterns comprises an associated score within the graph topology;
identify a set of unconnected nodes within the obtained set of patterns based on the associated score;
infer one or more edges to link the set of unconnected nodes based on machine learning and feedback techniques; and
provide a most-likely answer to the query based on the linking of the set of unconnected nodes.

2. The QA system according to claim 1, wherein the machine-readable instructions to obtain the query comprises instructions to present a blank record in a display that permits the user to specify the query.

3. The QA system according to claim 1, wherein the machine-readable instructions to obtain the query comprises instructions to obtain the query according to voice recognition via a voice sensor.

4. The QA system according to claim 1, wherein the machine-readable instructions to identify a set of unconnected nodes within the obtained set of patterns based on the associated score comprises instructions to identify a set of unconnected nodes having scores within a similarity threshold.

5. The QA system according to claim 1, wherein the most-likely answer is the actual answer.

6. The QA system according to claim 1, further comprising machine-readable instructions to provide a likelihood score associated with the most-likely answer.

7. The QA system according to claim 1, further comprising machine-readable instructions to verify whether the most-likely answer is the actual answer based on human feedback,

8. The QA system according to claim 1, wherein the machine learning and feedback techniques comprise neural networks.

9. The QA system according to claim 1, wherein the machine-readable instructions to provide a most-likely answer to the query based on the linking of the set of unconnected nodes further comprises machine-readable instructions to:
obtain a set of likely answers;
wherein the likely answers from the set are ranked by likelihood.

10. A method implemented by a query answering QA system that includes a physical processor implementing machine readable instructions, the method comprising:
obtaining a query provided by a user to query the graph topology, wherein an actual answer to the query is unknown from the graph topology;
querying a set of nodes and a set of edges in the graph topology associated with the obtained query,
wherein querying the set of nodes and edges comprises applying neighboring graph structure statistics to the set of nodes and edges to obtain a set of node grouping patterns; and
wherein each of the node grouping patterns comprises an associated score within the graph topology;
identifying a set of unconnected nodes within the obtained set of patterns based on the associated score;
inferring one or more edges to link the set of unconnected nodes based on machine learning and feedback techniques;
obtaining a set of likely answers to the query ranked by likelihood based on the linking of the set of unconnected nodes; and
providing a likely answer from the set based on a highest likelihood score.

11. The method of claim 10, wherein obtaining the query to query the graft comprises:
presenting a blank record that permits the user to specify the query; and
obtaining the query according to voice recognition.

12. The method of claim 10, wherein identifying a set of unconnected nodes within the obtained set of patterns based on the associated score comprises instructions to identify a set of unconnected nodes having a similar associated score.

13. The method of claim 10, wherein the most-likely answer is the actual answer.

14. The method of claim 10, further comprising providing the highest likelihood score.

15. The method of claim 10, further comprising verifying whether the most-likely answer is the actual answer based on human feedback.

16. The method of claim 10, wherein the machine learning and feedback techniques comprise neural networks.

17. A non-transitory machine-readable medium to be executed in a query answering QA system, the non-transitory machine-readable medium storing machine-readable instructions executable by a processor to cause the processor to:
obtain a query provided by a user to query the graph topology,
wherein an actual answer to the query is unknown from the graph topology;
query a set of nodes and a set of edges in the graph topology associated with the obtained query,
wherein querying the set of nodes and edges comprises applying neighboring graph structure statistics to the set of nodes and edges to obtain a set of node grouping patterns; and
wherein each of the node grouping patterns comprises an associated score within the graph topology;
identify a set of unconnected nodes within the obtained set of patterns based on the associated score;
infer one or more edges to link the set of unconnected nodes based on neural networks;
obtain a set of likely answers to the query ranked by likelihood based on the linking of the set of unconnected nodes; and
provide a likely answer from the set based on a highest likelihood score.

18. The non-transitory machine-readable medium of claim 17, further comprising machine-readable instructions to verify whether the most-likely answer is the actual answer based on human feedback.

19. The non-transitory machine-readable medium of claim 17, further comprising machine-readable instructions to provide the highest likelihood score.

20. The non-transitory machine-readable medium of claim 17, wherein the machine-readable instructions to identify a set of unconnected nodes within the obtained set of patterns based on the associated score comprises instructions to identify a set of unconnected nodes having a similar associated score.
